(19) United States
(12) Patent Application Publication
(10) Pub. No.: US 2021/0031740 A1
(43) Pub. Date: Feb. 4, 2021

(54) BRAKING SYSTEM ANDMETHOD FOR PROVIDING AN EXTRA TORQUE FROM A MOTOR TO A BRAKE PEDAL

(71) Applicant: Robert Bosch GmbH, Stuttgart (DE)

(72) Inventors: Patrick Christian Schaefer, Ludwigsburg (DE); James Zhu, South Lyon, MI (US); Hind Harkati, Heilbronn (DE); Benoit Herve, Stuttgart (DE); Karsten Bieltz, Mundelsheim (DE)

(21) Appl. No.: 16/964,107

(22) PCT Filed: Jan. 22, 2019
(86) PCT No.: PCT/EP2019/051468

§ 371 Date: Jul. 22, 2020

Related U.S. Application Data
(60) Provisional application No. 62/620,924, filed on Jan. 23, 2018.

(51) Int. Cl. B60T 8/40; B60T 7/04; H02P 6/08

(52) U.S. Cl. CPC B60T 8/409; H02P 6/08; B60T 7/042

(57) ABSTRACT

System (195) and method (300) for providing an extra torque from a motor (110) to a brake pedal (115). The system comprises a brake pedal (115) having an input rod; a motor (110); a sensor (125); and an electronic controller (130) configured to receive a velocity of the input rod of the brake pedal (115) from the sensor (125), determine a torque ratio based on the velocity, determine a differential stroke of the brake pedal (115), determine a torque offset based on the differential stroke, determine an extra torque based on the torque ratio and the torque offset, and control the motor (110) to apply the extra torque to the brake pedal (115).

### CROSS REFERENCE TO RELATED APPLICATIONS

This application claims priority to U.S. Provisional Patent Application No. 62/620,924, filed Jan. 23, 2018, the entire contents of which is incorporated by reference in its entirety.

### FIELD

Embodiments relate to systems and methods for providing an extra torque from a motor to a brake pedal.

### BACKGROUND

During depression of a brake pedal, a driver of a vehicle may experience (or feel) an immediate or abrupt increase in force that resists depression of the brake pedal. In order to improve pedal feel and usability, a means to “smooth” pedal feel and improve driver experience is needed.

### SUMMARY

One embodiment of the invention provides a system for providing an extra torque from a motor to a brake pedal. The system includes a brake pedal having an input rod; a motor; a sensor; and an electronic controller configured to receive a velocity of the input rod from the sensor, determine a torque ratio based on the velocity, determine a differential stroke of the brake pedal, determine a torque offset based on the differential stroke, determine an extra torque based on the torque ratio and the torque offset, and control the motor to apply the extra torque to the brake pedal.

Another embodiment of the invention provides a method for providing an extra torque from a motor to a brake pedal. The method includes receiving, with an electronic controller, a velocity of an input rod of a brake pedal from a sensor, determining, with the electronic controller, a torque ratio based on the velocity, determining, with the electronic controller, a differential stroke of brake pedal, determining, with the electronic controller, a torque offset based on the differential stroke of the brake pedal, determining, with the electronic controller, an extra torque based on the torque ratio and the torque offset, and applying, with a motor, the extra torque to the brake pedal.

Other aspects, features, and embodiments will become apparent by consideration of the detailed description and accompanying drawings.

### BRIEF DESCRIPTION OF THE DRAWINGS

FIG. 1 is an illustration of a vehicle including a system for providing an extra torque to a brake pedal according to one embodiment.

FIG. 2 is an illustration of an electronic controller according to one embodiment.

FIG. 3 is a flow chart for a method of providing an extra torque from a motor to a brake pedal according to one embodiment.

FIG. 4 illustrates a relationship between a velocity of an input rod and a torque ratio according to one embodiment.

FIG. 5 illustrates a relationship between a differential stroke and a torque offset according to one embodiment.

### DETAILED DESCRIPTION

Before any embodiments are explained in detail, it is to be understood that this disclosure is not intended to be limited in its application to the details of construction and the arrangement of components set forth in the following description or illustrated in the following drawings. Embodiments are capable of other configurations and of being practiced or of being carried out in various ways.

A plurality of hardware and software based devices, as well as a plurality of different structural components may be used to implement various embodiments. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more input/output interfaces, one or more application specific integrated circuits (ASICs), and various connections (for example, a system bus) connecting the various components.

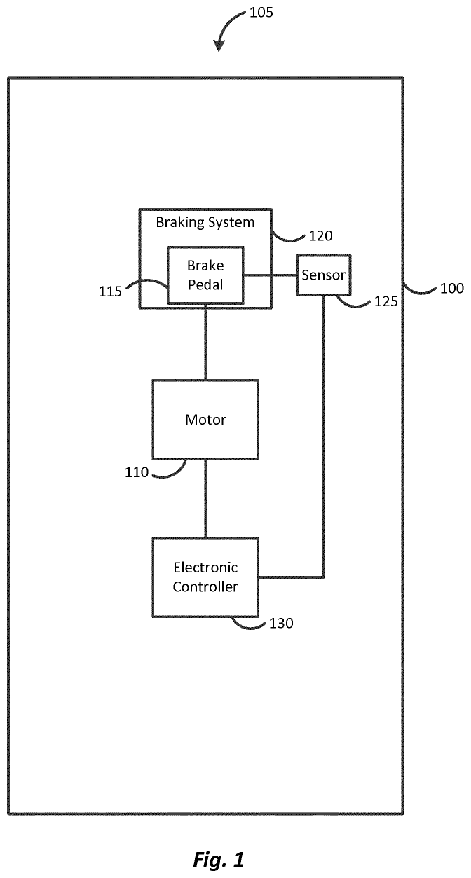

FIG. 1 illustrates a vehicle 100 with a system 105 for providing an extra torque from a motor 110 to a brake pedal 115 according to one embodiment.

The vehicle 100 may be an automobile, a motorcycle, a semi tractor-trailer, and the like. The vehicle 100 includes a braking system 120 and may have other systems (for example, steering, powertrain, suspension, and others) that are not described herein.

The system 105 includes the motor 110, the brake pedal 115, which is part of the braking system 120, a sensor 125, and an electronic controller 130.

In one embodiment, the motor 110 is an electrical motor. The motor 110 is configured to provide an extra torque to the brake pedal 115. The motor 110 may be mechanically coupled to the brake pedal 115 in order to provide the torque to the brake pedal 115. In some embodiments, the motor 110 is controlled to apply the torque to the brake pedal 115 in all cases of the brake pedal 115 being depressed. In some embodiments, the motor 110 is controlled to apply the extra torque (as discussed below) to the brake pedal 115.

As noted, the brake pedal 115 is a component of the braking system 120. The brake pedal 115 is configured to be depressed (such as by a foot of a user of the vehicle 100) or otherwise moved in order to indicate to the braking system 120 to apply at least one brake to a wheel of the vehicle 100. The brake pedal 115 includes an input rod. If the braking system 120 is a purely hydraulic braking system, when the brake pedal 115 is depressed, it causes the input rod to be pressed into a master cylinder of the braking system 120 to exert a pressure on braking fluid in the master cylinder. In other embodiments, the braking system 120 is a “brake-by-wire” system and includes one or more electronic components. In “brake-by-wire” embodiments, movement of the brake pedal 115 or of the input rod is sensed, for example, when the brake pedal 115 is depressed. The braking system 120 brakes one or more wheels of the vehicle 100 (for example, by causing a caliper to press against a brake rotor) based on the sensed movement (for example, a position, speed, or velocity of the input rod.

The sensor 125 may be a velocity sensor (such as a piezoelectric velocity sensor, a moving coil velocity sensor, and the like). The sensor 125 is electronically coupled to the brake pedal 115 and is configured to determine a velocity of the input rod of the brake pedal 115 when the brake pedal 115 is depressed or otherwise moved. In some embodiments, the sensor 125 may further determine a position of the input rod, a displacement of the input rod, and other parameters of the input rod in response to the braking pedal 115 being depressed or otherwise moved (for example, released).

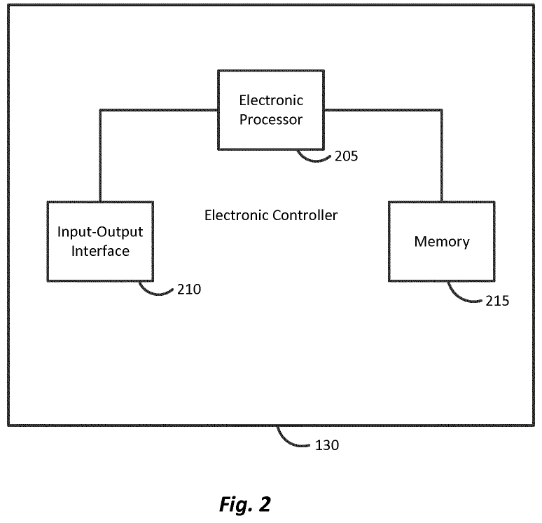

The electronic controller 130 is illustrated in FIG. 2. In the example shown, the electronic controller 130 is electronically coupled to the sensor 125 and the motor 110. The electronic controller 130 may include an electronic processor 205, and input-output interface 210, and a memory 215.

The electronic processor 205 may be a programmable electronic microprocessor, an electronic microcontroller, an application-specific integrated circuit (“ASIC”), and the like. The electronic processor 205 is communicatively coupled to the input-output interface 210 and the memory 215. The electronic processor 205, in coordination with the memory 215 and the input-output interface 210, is configured to implement, among other things, the methods described herein.

It is to be understood that the electronic controller 130 may include a plurality of electrical and electronic components that provide power, operation control, and protection to the components and modules within the electronic controller 130 that are not described herein.

The electronic controller 130 may be implemented in several independent controllers (for example, programmable electronic control units) each configured to perform specific functions or sub-functions. Additionally, the electronic controller 130 may contain sub-modules that include additional electronic processors, memory, or ASICs for handling input/output functions, processing of signals, and application of the methods listed below. In other embodiments, the electronic controller 130 includes additional, fewer, or different components.

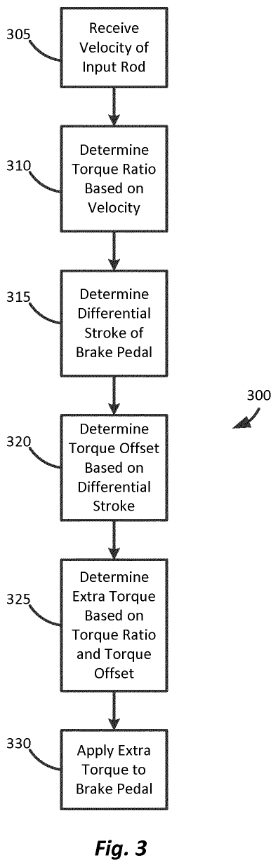

An example method 300 for providing an extra torque from the motor 110 to the braking pedal is shown in a flow chart in FIG. 3.

The method 300 includes receiving, with the electronic controller 130, a velocity of the input rod from the sensor 125 (at block 305). For example, as the brake pedal 115 is depressed and the input rod is moved, the sensor 125 detects the velocity of the input rod and sends a signal representative of the velocity of the input rod to the electronic controller 130.

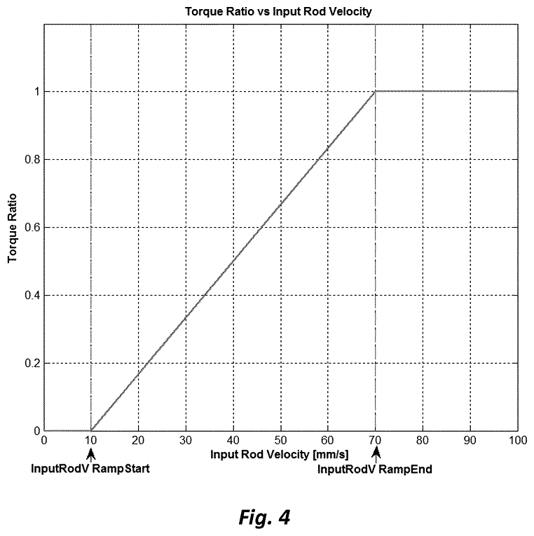

The method 300 also includes determining, with the electronic controller 130, based upon the received velocity of the input rod, a torque ratio (at block 310). For example, FIG. 4 illustrates a relationship between a velocity of an input rod and a torque ratio according to one embodiment. As the velocity of the input rod increases, the corresponding torque ratio value is larger. For example, in one embodiment, the electronic controller 130 receives a velocity of 40 millimeters a second from the sensor 125. The electronic controller 130 then determines that the torque ratio is 0.5. In some embodiments, the electronic controller 130 saves the torque ratio value to the memory 215.

The method 300 also includes determining, using the electronic controller 130, a differential stroke of the brake pedal 115 (at block 315). The differential stroke of the brake pedal 115 may be a distance traveled by the brake pedal 115, a distance past a certain threshold traveled by the brake pedal 115, and the like. The differential stroke of the brake pedal 115 is measured, in one embodiment, by the sensor 125. In other embodiments, a separate sensor measures the differential stroke. The differential stroke may be determined by the sensor 125 measuring a displacement of the brake pedal 115 (for example, by measuring a displacement of the input rod) and sending the displacement to the electronic controller 130. The electronic controller 130 then may subtract a constant value to determine the differential stroke. The electronic controller 130 may further determine the constant value (for example, 1 millimeter), and the constant value may be adjustable for a user. In some embodiments, the distance measured is a difference between a position of the input rod and a reference point in the braking system 120. For example, the reference point may be an actuator located at an end of a main cylinder of the braking system 120 opposite of where the input rod enters the main cylinder. The distance between the input rod and the actuator, as it decreases, is measured as the distance the input rod has traveled (for example, if the distance between the input rod and the actuator is 0.5 millimeters).

The velocity of the input rod may also be measured starting at a reference point, such as a point located at the end of a main cylinder of the braking system 120 where the input rod enters the main cylinder.

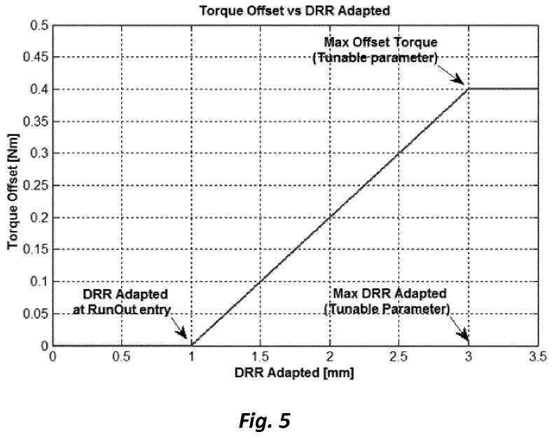

The method 300 also includes determining, using the electronic controller 130, a torque offset based on the differential stroke (at block 320). For example, FIG. 5 illustrates a relationship between a differential stroke and a torque offset according to one embodiment. As shown, a torque offset is determined based upon a value of the differential stroke. For example, if the electronic controller 130 determines that the differential stroke is 2 millimeters, the electronic controller 130 then determines that the necessary torque offset is 0.2 Newton-meters.

A maximum torque offset may be set by a user (for example, a maximum amount of torque offset that can be provided regardless of differential stroke). For example, in FIG. 5, the maximum torque offset is 0.4 Newton-meters. Past this value, for any corresponding differential stroke value, the maximum torque offset that can be provided is 0.4 Newton-meters. This parameter may be tunable by a user. For example, a user may access a touch screen electrically coupled to the electronics controller 130 that allows the user to set the maximum torque offset value in memory.

The method 300 also includes determining, using the electronic controller 130, an extra torque to be supplied to the brake pedal 115 based upon the torque ratio and torque offset (at block 325). For example, based upon the torque ratio and the torque offset, the electronic controller 130 determines that an extra torque is necessary for the brake pedal 115. The extra torque may be to improve pedal feel (smooth operation of the brake pedal 115 as perceived by a user of the vehicle 100) or to prevent an immediate sensation of force pushing back on the brake pedal 115.

The method 300 also includes applying, with the motor 110, the extra torque to the brake pedal 115 (at block 330). The electronic controller 130 is configured to generate a control signal to the motor 110 to control the motor to provide the determined extra torque to the brake pedal 115.

In some embodiments, an operator of the vehicle 100 may depress the brake pedal 115 to a point where the input rod cannot move any further (for example, to where the input rod impacts an actuator). The electronic controller 130 may be configured, using data from the sensor 125 (such as velocity or position of the input rod), to determine the operator of the vehicle 100 is still depressing the brake pedal 115, even though the input rod cannot move any further. In this case, the electronic controller 130 may control the motor 110 to provide a larger amount of extra torque to the brake pedal 115 than would be determined based on the velocity or position of the input rod. In one example, the electronic controller 130 determines that, from data from the sensor 125, the brake pedal 115 is being depressed even after the input rod cannot move any further. The electronic controller 130 may then control the motor 110 to provide a larger amount of extra torque to the brake pedal 115 based on the amount of time the brake pedal 115 had been depressed without the input rod moving.

Thus, embodiments described herein are generally directed towards a system and methods for providing an extra torque from a motor to a brake pedal.

Various features, advantages, and embodiments are set forth in the following claims.

What is claimed is:

1. A braking system for providing an extra torque from a motor to a brake pedal, the system comprising:
a brake pedal including an input rod;
a motor;
a sensor; and
an electronic controller configured to
receive a velocity of the input rod of the brake pedal from the sensor,
determine a torque ratio based on the velocity,
determine a differential stroke of the brake pedal,
determine a torque offset based on the differential stroke, determine an extra torque based on the torque ratio and the torque offset, and
control the motor to apply the extra torque to the brake pedal.

2. The system of claim 1, wherein the differential stroke is determined as a displacement of the brake pedal.

3. The system of claim 1, wherein the differential stroke is determined as a displacement of the brake pedal beyond a reference point in the braking system.

4. The system of claim 1, wherein the velocity of the input rod is determined after a reference point in the braking system.

5. The system of claim 1, wherein a maximum torque offset is set by a user.

6. The system of claim 5, wherein if the electronic controller determines that the torque offset would be greater than the maximum torque offset, the electronic controller uses the maximum torque offset to determine the extra torque.

7. The system of claim 1, wherein the extra torque smooths operation of the brake pedal.

8. The system of claim 1, wherein the extra torque prevents an immediate sensation of force to a user of the brake pedal.

9. The system of claim 1, wherein the electronic controller is further configured to determine, based upon a signal from the sensor, that the brake pedal is still being depressed but that the input rod cannot be depressed any further.

10. The system of claim 9, wherein the electronic controller is further configured to provide the extra torque as if the input rod was being depressed beyond a point at which the input rod can be depressed.

11. A method for providing an extra torque from a motor to a brake pedal, the method comprising:
receiving, at an electronic controller, a velocity of an input rod of a brake pedal from a sensor;
determining, with the electronic controller, a torque ratio based upon the velocity;
determining, with the electronic controller, a differential stroke of the brake pedal based upon the torque ratio;
determining, with the electronic controller, a torque offset based on the differential stroke;
determining, with the electronic controller, an extra torque based on the torque ratio and the torque offset; and
controlling, with the electronic controller, a motor to apply the extra torque to the brake pedal.

12. The method of claim 11, wherein the differential stroke is determined as a displacement of the brake pedal.

13. The method of claim 11, wherein the differential stroke is determined as a displacement of the brake pedal beyond a reference point in a braking system.

14. The method of claim 11, wherein the velocity of the input rod is determined after a reference point in a braking system.

15. The method of claim 11, wherein a maximum torque offset is set by a user.

16. The method of claim 15, the method further comprising determining, with the electronic controller, that the torque offset would be greater than the maximum torque offset; and
using the maximum torque offset to determine the extra torque if the torque offset is greater than the maximum torque offset.

17. The method of claim 11, wherein the extra torque smooths operation of the brake pedal.

18. The method of claim 11, wherein the extra torque prevents an immediate sensation of force to a user of the brake pedal.

19. The method of claim 11, further comprising determining, with the electronic controller, that the brake pedal is still being depressed but that the input rod cannot be depressed any further based upon a signal from the sensor.

20. The method of claim 19, further comprising providing, with the electronic controller, the extra torque as if the input rod was being depressed beyond a point at which the input rod can be depressed.
